(19) United States
(12) Patent Application Publication
(10) Pub. No.: US 2019/0370074 A1
(43) Pub. Date: Dec. 5, 2019

(54) METHODS AND APPARATUS FOR MULTIPLE ASYNCHRONOUS CONSUMERS

(71) Applicant: Intel Corporation, Santa Clara, CA (US)

(72) Inventors: Roni Rosner, Binyamina (IL); Moshe Maor, Kiryat Mozking (IL); Michael Behar, Zichron Yaakov (IL); Ronen Gabbai, Ramat Hashofet (IL); Zigi Walter, Haifa (IL); Oren Agam, Zichron Yaacov (IL)

(21) Appl. No.: 16/541,997

(22) Filed: Aug. 15, 2019

(51) Int. Cl. G06F 9/50; G06F 9/46

(52) U.S. Cl. CPC G06F 9/5022; G06F 9/5072; G06F 9/5077; G06F 9/468

(57) ABSTRACT

An apparatus includes a communication processor to receive configuration information from a producing compute building block; a credit generator to generate a number of credits for the producing compute building block corresponding to the configuration information, the configuration information including characteristics of a buffer; a source identifier to analyze a returned credit to determine whether the returned credit originates from the producing compute building block or a consuming compute building block; and a duplicator to, when the returned credit originates from the producing compute building block, multiply the returned credit by a first factor, the first factor indicative of a number of consuming compute building blocks identified in the configuration information.

### FIELD OF THE DISCLOSURE

This disclosure relates generally to consumers, and, more particularly, to multiple asynchronous consumers.

### BACKGROUND

Computer hardware manufacturers develop hardware components for use in various components of computer platforms. For example, computer hardware manufacturers develop motherboards, chipsets for motherboards, central processing units (CPUs), hard disk drives (HDDs), solid state drives (SSDs), and other computer components. Additionally, computer hardware manufacturers develop processing elements, known as accelerators, to accelerate the processing of a workload. For example, an accelerator can be a CPU, a graphics processing units (GPUs), a vision processing units (VPUs), and/or a field programmable gate arrays (FPGAs).

### BRIEF DESCRIPTION OF THE DRAWINGS

FIG. 1 is a block diagram illustrating an example computing system.

FIG. 2 is a block diagram illustrating an example computing system including an example compiler and an example credit manager.

FIG. 3 is an example block diagram illustrating the example credit manager of FIG. 2.

FIGS. 4A and 4B are graphical illustrations of an example pipeline representative of an operation of the credit manager during execution of a workload.

FIG. 5 is a flowchart representative of machine readable instructions which may be executed to implement an example producing compute building block (CBB) of FIGS. 4A and/or 4B.

FIG. 6 is a flowchart representative of machine readable instructions which may be executed to implement the example credit manager of FIGS. 2, 3, 4A, and/or 4B.

FIG. 7 is a flowchart representative of machine readable instructions which may be executed to implement an example consuming CBB of FIGS. 4A and/or 4B.

FIG. 8 is a block diagram of an example processor platform structured to execute the instructions of FIGS. 5, 6 and/or 7 to implement the example producing CBB, the example one or more consuming CBBs, the example credit manager, and/or the accelerator of FIGS. 2, 3, 4A and/or 4B.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Many computing hardware manufacturers develop processing elements, known as accelerators, to accelerate the processing of a workload. For example, an accelerator can be a CPU, a GPU, a VPU, and/or an FPGA. Moreover, accelerators, while capable of processing any type of workload, are designed to optimize particular types of workloads. For example, while CPUs and FPGAs can be designed to handle more general processing, GPUs can be designed to improve the processing of video, games, and/or other physics and mathematically based calculations, and VPUs can be designed to improve the processing of machine vision tasks.

Additionally, some accelerators are designed specifically to improve the processing of artificial intelligence (AI) applications. While a VPU is a specific type of AI accelerator, many different AI accelerators can be used. In fact, many AI accelerators can be implemented by application specific integrated circuits (ASICs). Such ASIC-based AI accelerators can be designed to improve the processing of tasks related to a particular type of AI, such as machine learning (ML), deep learning (DL), and/or other artificial machine-driven logic including support vector machines (SVMs), neural networks (NNs), recurrent neural networks (RNNs), convolutional neural networks (CNNs), long short term memory (LSTM), gate recurrent units (GRUs), etc.

Computer hardware manufactures also develop heterogeneous systems that include more than one type of processing element. For example, computer hardware manufactures may combine both general purpose processing elements, such as CPUs, with either general purpose accelerators, such as FPGAs, and/or more tailored accelerators, such as GPUs. VPUs. and/or other AI accelerators. Such heterogeneous systems can be implemented as systems on a chip (SoCs).

When a developer desires to execute a function, algorithm, program, application, and/or other code on a heterogeneous system, the developer and/or software generates a schedule (e.g., a graph) for the function, algorithm, program, application, and/or other code at compile time. Once a schedule is generated, the schedule is combined with the function, algorithm, program, application, and/or other code specification to generate an executable file (either for Ahead of Time or Just in Time paradigms). Moreover, the schedule combined with the function, algorithm, program, application, kernel, and/or other code may be represented as a graph including nodes, where the graph represents a workload and each node (e.g., a workload node) represents a particular task to be executed of that workload. Furthermore, the connections between the different nodes in the graph represent edges. The edges of the in workload represent a stream of data from one node to another. The stream of data is identified as an input stream or an output stream.

In some examples, one node (e.g., a producer) may be connected via an edge to a different node (e.g., a consumer). In this manner, the producer node streams data (e.g., writes data) to a consumer node who consumes (e.g., reads) the data. In other examples, a producer node can have one or more consumer nodes, such that the producer node streams data via one or more edges to the one or more consumer nodes. A producer node generates the stream of data for a consumer node, or multiple consumer nodes, to read the data and operate on. A node can be identified as a producer or consumer during the compilation of the graph. For example, a graph compiler receives a schedule (e.g., a graph) and assigns various workload nodes of the workload to various compute building blocks (CBBs) located within an accelerator. During the assignment of workload nodes, a graph compiler assigns the CBB with a node that produces data, and that CBB can become a producer. Additionally, the graph compiler can assign the CBB with a node that consumes the data of the workload, and that CBB can become a consumer. In some examples, the CBB to which a node is assigned may include multiple roles simultaneously. For example, the CBB is the consumer of data produced by nodes in the graph connected via incoming edges, and the producer of data consumed by nodes in the graph connected by outgoing edges.

The amount of data a producer node streams is a run-time variable. For example, when a stream of data is a run-time variable, the consumer does not know ahead of time the amount of data in that stream. In this manner, the data in the stream might be data dependent which indicates that a consumer node will not know the amount of data the consumer node receives until the stream is complete.

In some applications where a graph has configured more than one consumer node for a single producer node, the relative speed of execution of the consumer nodes and the producer nodes can be unknown. For example, a producer node can produce data exponentially faster than a consumer node can consume (e.g., read) that data. Additionally, the consumer nodes may vary in speed of execution such that one consumer node can read data faster than a second consumer node can read data, or vice versa. In this example, it can be difficult to configure/compile a graph to perform a workload with multiple consumer nodes because not all of the consumer nodes will execute synchronously.

Examples disclosed herein include methods and apparatus to seamlessly implement multi-consumer data streams. For example, methods and apparatus disclosed herein allow a plurality of different types of consumers to read data provided by a single producer by abstracting away data types, amount of data, and number of consumers. For example, examples disclosed herein utilize a cyclic buffer to store data for writing to and reading from by consumers and producer. As used herein, “circular buffer,” “circular que,” “ring buffer,” “cyclic buffer,” etc., are defined as a data structure that uses a single, fixed-size buffer as if the buffer were connected end-to-end. Cyclic buffers are utilized for buffering data streams. A data buffer is a region of physical memory storage used to temporarily store data while the data is being moved from one place to another (e.g., from a producer to one or more consumers).

Additionally, examples disclosed herein utilize a credit manager to assign credits to a producer and multiple consumers as a means to allow multi-consumer data streams between one producer and multiple consumers in an accelerator. For example, a credit manager communicates information between the producer and multiple consumers indicative of when a producer can write data to the buffer and when a consumer can read data from the buffer. In this manner, the producer and each one of the consumers are indifferent to the number of consumers the producer is to write to.

In examples disclosed herein, a “credit” is similar to a semaphore. A semaphore is a variable or abstract data type used to control access to a common resource (e.g., a cyclic buffer) by multiple processes (e.g., producers and consumers) in a concurrent system (e.g., a workload). In some examples, the credit manager generates a specific number of credits or adjusts the number of credits available based on availability in a buffer and the source of the credit (e.g., where did the credit come from). In this manner, the credit manager eliminates the need for a producer to be configured to communicate directly with a plurality of consumers. To configure the producer to communicate directly with a plurality of consumers is computationally intensive because the producer would need to know the type of consumer, the speed at which the consumer can read data, the location of the consumer, etc.

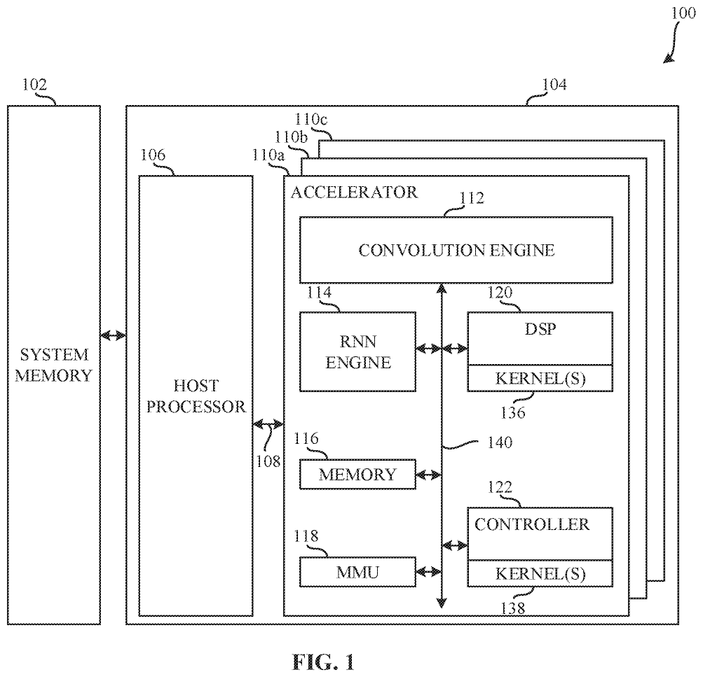

FIG. 1 is a block diagram illustrating an example computing system 100. In the example of FIG. 1, the computing system 100 includes an example system memory 102 and an example heterogeneous system 104. The example heterogeneous system 104 includes an example host processor 106, an example first communication bus 108, an example first accelerator 110a, an example second accelerator 110b, and an example third accelerator 110c. Each of the example first accelerator 110a, the example second accelerator 110b, and the example third accelerator 110c includes a variety of CBBs that are both generic and/or specific to the operation of the respective accelerators.

In the example of FIG. 1, the system memory 102 is coupled to the heterogeneous system 104. The system memory 102 is a memory. In FIG. 1, the system memory 102 is a shared storage between at least one of the host processor 106, the first accelerator 110a, the second accelerator 110b and the third accelerator 110c. In the example of FIG. 1, the system memory 102 is a physical storage local to the computing system 100; however, in other examples, the system memory 102 may be external to and/or otherwise be remote with respect to the computing system 100. In further examples, the system memory 102 may be a virtual storage. In the example of FIG. 1, the system memory 102 is a non-volatile memory (e.g., read only memory (ROM), programmable ROM (PROM), erasable PROM (EPROM), electrically erasable PROM (EEPROM), etc.). In other examples, the system memory 102 may be a non-volatile basic input/output system (BIOS) or a flash storage. In further examples, the system memory 102 may be a volatile memory.

In FIG. 1, the heterogeneous system 104 is coupled to the system memory 102. In the example of FIG. 1, the heterogeneous system 104 processes a workload by executing the workload on the host processor 106 and/or one or more of the first accelerator 110a, the second accelerator 110b, or the third accelerator 110c. In FIG. 1, the heterogeneous system 104 is a system on a chip (SoC). Alternatively, the heterogeneous system 104 may be any other type of computing or hardware system.

In the example of FIG. 1, the host processor 106 is a processing element configured to execute instructions (e.g., machine-readable instructions) to perform and/or otherwise facilitate the completion of operations associated with a computer and/or or computing device (e.g., the computing system 100). In the example of FIG. 1, the host processor 106 is a primary processing element for the heterogeneous system 104 and includes at least one core. Alternatively, the host processor 106 may be a co-primary processing element (e.g., in an example where more than one CPU is utilized) while, in other examples, the host processor 106 may be a secondary processing element.

In the illustrated example of FIG. 1, one or more of the first accelerator 110a, the second accelerator 110b, and/or the third accelerator 110c are processing elements that may be utilized by a program executing on the heterogeneous system 104 for computing tasks, such as hardware acceleration. For example, the first accelerator 110a is a processing element that includes processing resources that are designed and/or otherwise configured or structured to improve the processing speed and overall performance of processing machine vision tasks for AI (e.g., a VPU).

In examples disclosed herein, each of the host processor 106, the first accelerator 110a, the second accelerator 110b, and the third accelerator 110c is in communication with the other elements of the computing system 100 and/or the system memory 102. For example, the host processor 106, the first accelerator 110a, the second accelerator 110b, the third accelerator 110c, and/or the system memory 102 are in communication via the first communication bus 108. In some examples disclosed herein, the host processor 106, the first accelerator 110a, the second accelerator 110b, the third accelerator 110c, and/or the system memory 102 may be in communication via any suitable wired and/or wireless communication method. Additionally, in some examples disclosed herein, each of the host processor 106, the first accelerator 110a, the second accelerator 110b, the third accelerator 110c, and/or the system memory 102 may be in communication with any component exterior to the computing system 100 via any suitable wired and/or wireless communication method.

In the example of FIG. 1, the first accelerator 110a includes an example convolution engine 112, an example RNN engine 114, an example memory 116, an example memory management unit (MMU) 118, an example digital signal processor (DSP) 120, and an example controller 122. In examples disclosed herein, any of the convolution engine 112, the RNN engine 114, the memory 116, the memory management unit (MMU) 118, the DSP 120, and/or the controller 122 may be referred to as a CBB. Each of the example convolution engine 112, the example RNN engine 114, the example memory 116, the example MMU 118, the example DSP 120, and the example controller 122 includes at least one scheduler.

In the example of FIG. 1, the convolution engine 112 is a device that is configured to improve the processing of tasks associated convolution. Moreover, the convolution engine 112 improves the processing of tasks associated with the analysis of visual imagery and/or other tasks associated with CNNs. In FIG. 1, the RNN engine 114 is a device that is configured to improve the processing of tasks associated with RNNs. Additionally, the RNN engine 114 improves the processing of tasks associated with the analysis of unsegmented, connected handwriting recognition, speech recognition, and/or other tasks associated with RNNs.

In the example of FIG. 1, the memory 116 is a shared storage between at least one of the convolution engine 112, the RNN engine 114, the MMU 118, the DSP 120, and the controller 122 including direct memory access (DMA) functionality. Moreover, the memory 116 allows at least one of the convolution engine 112, the RNN engine 114, the MMU 118, the DSP 120, and the controller 122 to access the system memory 102 independent of the host processor 106. In the example of FIG. 1, the memory 116 is a physical storage local to the first accelerator 110a; however, in other examples, the memory 116 may be external to and/or otherwise be remote with respect to the first accelerator 110a. In further examples, the memory 116 may be a virtual storage. In the example of FIG. 1, the memory 116 is a persistent storage (e.g., read only memory (ROM), programmable ROM (PROM), erasable PROM (EPROM), electrically erasable PROM (EEPROM), etc.). In other examples, the memory 116 may be a persistent basic input/output system (BIOS) or a flash storage. In further examples, the memory 116 may be a volatile memory.

In the example of FIG. 1, the example MMU 118 is a device that includes references to all the addresses of the memory 116 and/or the system memory 102. The MMU 118 additionally translates virtual memory addresses utilized by one or more of the convolution engine 112, the RNN engine 114, the DSP 120, and/or the controller 122 to physical addresses in the memory 116 and/or the system memory 102.

In the example of FIG. 1, the DSP 120 is a device that improves the processing of digital signals. For example, the DSP 120 facilitates the processing to measure, filter, and/or compress continuous real-world signals such as data from cameras, and/or other sensors related to computer vision. In FIG. 1, the controller 122 is implemented as a control unit of the first accelerator 110a. For example, the controller 122 directs the operation of the first accelerator 110a In some examples, the controller 122 implements a credit manager. Moreover, the controller 122 can instruct one or more of the convolution engine 112, the RNN engine 114, the memory 116, the MMU 118, and/or the DSP 120 how to respond to machine readable instructions received from the host processor 106.

In the example of FIG. 1, the convolution engine 112, the RNN engine 114, the memory 116, the MMU 118, the DSP 120, and the controller 122 includes a respective scheduler to determine when each of the convolution engine 112, the RNN engine 114, the memory 116, the MMU 118, the DSP 120, and the controller 122, respectively, executes a portion of a workload that has been offloaded and/or otherwise sent to the first accelerator 110a.

In examples disclosed herein, each of the convolution engine 112, the RNN engine 114, the memory 116, the MMU 118, the DSP 120, and the controller 122 is in communication with the other elements of the first accelerator 110a. For example, the convolution engine 112, the RNN engine 114, the memory 116, the MMU 118, the DSP 120, and the controller 122 are in communication via an example second communication bus 140. In some examples, the second communication bus 140 may be implemented by a computing fabric. In some examples disclosed herein, the convolution engine 112, the RNN engine 114, the memory 116, the MMU 118, the DSP 120, and the controller 122 may be in communication via any suitable wired and/or wireless communication method. Additionally, in some examples disclosed herein, each of the convolution engine 112, the RNN engine 114, the memory 116, the MMU 118, the DSP 120, and the controller 122 may be in communication with any component exterior to the first accelerator 110a via any suitable wired and/or wireless communication method.

As previously mentioned, any of the example first accelerator 110a, the example second accelerator 110b, and/or the example third accelerator 110c may include a variety of CBBs either generic and/or specific to the operation of the respective accelerators. For example, each of the first accelerator 110a, the second accelerator 110b, and the third accelerator 110c includes generic CBBs such as memory, an MMU, a controller, and respective schedulers for each of the CBBs. Additionally or alternatively, external CBBs not located in any of the first accelerator 110a, the example second accelerator 110b, and/or the example third accelerator 110c may be included and/or added. For example, a user of the computing system 100 may operate an external RNN engine utilizing any one of the first accelerator 110a, the second accelerator 110b, and/or the third accelerator 110c.

While, in the example of FIG. 1, the first accelerator 110a implements a VPU and includes the convolution engine 112, the RNN engine 114, and the DSP 120, (e.g., CBBs specific to the operation of specific to the operation of the first accelerator 110a), the second accelerator 110b and the third accelerator 110c may include additional or alternative CBBs specific to the operation of the second accelerator 110b and/or the third accelerator 110c. For example, if the second accelerator 110b implements a GPU, the CBBs specific to the operation of the second accelerator 110b can include a thread dispatcher, a graphics technology interface, and/or any other CBB that is desirable to improve the processing speed and overall performance of processing computer graphics and/or image processing. Moreover, if the third accelerator 110c implements a FPGA, the CBBs specific to the operation of the third accelerator 110c can include one or more arithmetic logic units (ALUs), and/or any other CBB that is desirable to improve the processing speed and overall performance of processing general computations.

While the heterogeneous system 104 of FIG. 1 includes the host processor 106, the first accelerator 110a, the second accelerator 110b, and the third accelerator 110c, in some examples, the heterogeneous system 104 may include any number of processing elements (e.g., host processors and/or accelerators) including application-specific instruction set processors (ASIPs), physic processing units (PPUs), designated DSPs, image processors, coprocessors, floating-point units, network processors, multi-core processors, and front-end processors.

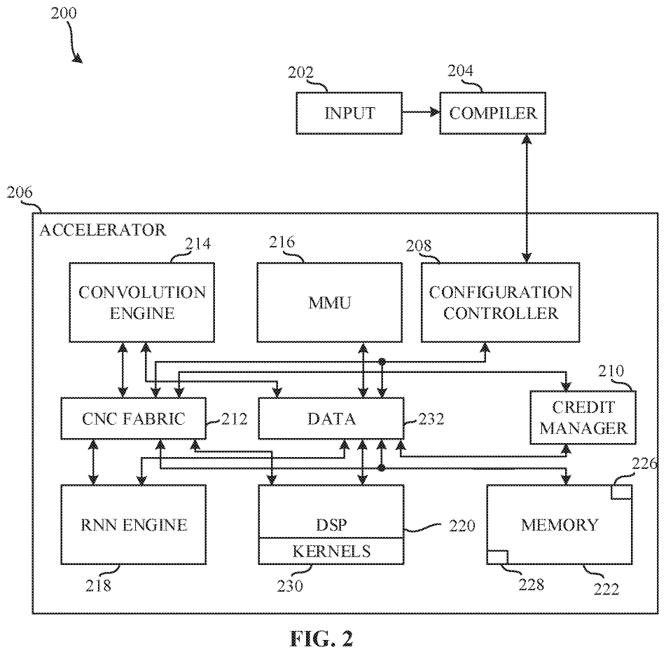

FIG. 2 is a block diagram illustrating an example computing system 200 including an example input 202, an example compiler 204, and an example accelerator 206. In FIG. 2, the input 202 is coupled to the compiler 204. The input 202 is a workload to be executed by the accelerator 206.

In the example of FIG. 2, the input 202 is, for example, a function, algorithm, program, application, and/or other code to be executed by the accelerator 206. In some examples, the input 202 is a graph description of a function, algorithm, program, application, and/or other code. In additional or alternative examples, the input 202 is a workload related to AI processing, such as deep learning and/or computer vision.

In the illustrated example of FIG. 2, the compiler 204 is coupled to the input 202 and the accelerator 206. The compiler 204 receives the input 202 and compiles the input 202 into one or more executables to be executed by the accelerator 206. For example, the compiler 204 is a graph compiler that receives the input 202 and assigns various workload nodes of the workload (e.g., the input 202) to various CBBs of the accelerator 206. Additionally, the compiler 204 allocates memory for one or more buffers in the memory of the accelerator 206. For example, the compiler 204 determines the location and the size (e.g., number of slots and number of bits that may be stored in each slot) of the buffers in memory. In this manner, an executable of the executables compiled by the compiler 204 will include the buffer characteristics. In the illustrated example of FIG. 2, the compiler 204 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), DSP(s), etc.

In operation, the compiler 204 receives the input 202 and compiles the input 202 (e.g., workload) into one or more executable files to be executed by the accelerator 206. For example, the compiler 204 receives the input 202 and assigns various workload nodes of the input 202 (e.g., the workload) to various CBBs (e.g., any of the convolution engine 214, the MMU 216, the RNN engine 218, the DSP 220, and/or the DMA 226) of the accelerator 206. Additionally, the compiler 204 allocates memory for one or more buffers 228 in the memory 222 of the accelerator 206.

In the example of FIG. 2, the accelerator 206 includes an example configuration controller 208, an example credit manager 210, an example control and configure (CnC) fabric 212, an example convolution engine 214, an example MMU 216, an example RNN engine 218, an example DSP 220, an example memory 222, and an example data fabric 232. In the example of FIG. 2, the memory 222 includes an example DMA unit 226 and an example one or more buffers 228.

In the example of FIG. 2, the configuration controller 208 is coupled to the compiler 204, the CnC fabric 212, and the data fabric 232. In examples disclosed herein, the configuration controller 208 is implemented as a control unit of the accelerator 206. In examples disclosed herein, the configuration controller 208 obtains the executable file from the compiler 204 and provides configuration and control messages to the various CBBs in order to perform the tasks of the input 202 (e.g., workload). In such an example disclosed herein, the configuration and control messages may be generated by the configuration controller 208 and sent to the various CBBs and/or kernels 230 located in the DSP 220. For example, the configuration controller 208 parses the input 202 (e.g., executable, workload, etc.) and instructs one or more of the convolution engine 214, the MMU 216, the RNN engine 218, the DSP 220, the kernels 230, and/or the memory 222 how to respond to the input 202 and/or other machine readable instructions received from the compiler 204 via the credit manager 210.

Additionally, the configuration controller 208 is provided with buffer characteristic data from the executables of the compiler 204. In this manner, the configuration controller 208 initializes the buffers (e.g., the buffer 228) in memory to be the size specified in the executables. In some examples, the configuration controller 208 provides configuration control messages to one or more CBBs including the size and location of each buffer initialized by the configuration controller 208.

In the example of FIG. 2, the credit manager 210 is coupled to the CnC fabric 212 and the data fabric 232. The credit manager 210 is a device that manages credits associated with one or more of the convolution engine 214, the MMU 216, the RNN engine 218, and/or the DSP 220. In some examples, the credit manager 210 can be implemented by a controller as a credit manager controller. Credits are representative of data associated with workload nodes that are available in the memory 222 and/or the amount of space available in the memory 222 for the output of the workload node. For example, the credit manager 210 and/or the configuration controller 208 can partition the memory 222 into one or more buffers (e.g., the buffers 228) associated with each workload node of a given workload based on the one or more executables received from the compiler 204.

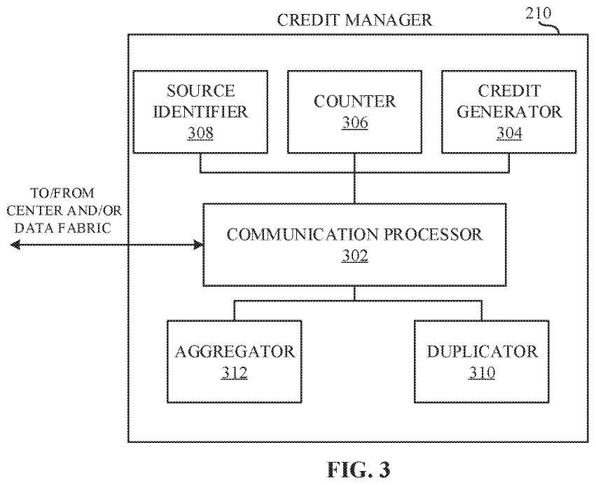

In examples disclosed herein, in response to instructions received from the configuration controller 208 indicating to execute a certain workload node, the credit manager 210 provides corresponding credits to the CBB acting as the initial producer. Once the CBB acting as the initial producer completes the workload node, the credits are sent back to the point of origin as seen by the CBB (e.g., the credit manager 210). The credit manager 210, in response to obtaining the credits from the producer, transmits the credits to the CBB acting as the consumer. Such an order of producer and consumers is determined using the executable generated by the compiler 204 and provided to the configuration controller 208. In this manner, the CBBs communicate an indication of ability to operate via the credit manager 210, regardless of their heterogenous nature. A producer CBB produces data that is utilized by another CBB whereas a consumer CBB consumes and/or otherwise processes data produced by another CBB. The credit manager 210 is discussed in further detail below in connection with FIG. 3.

In the example of FIG. 2, the CnC fabric 212 is coupled to the credit manager 210, the convolution engine 214, the MMU 216, the RNN engine 218, the DSP 220, the memory 222, the configuration controller 208, and the data fabric 232. The CnC fabric 212 is a network of wires and at least one logic circuit that allow one or more of the credit manager 210, the convolution engine 214, the MMU 216, the RNN engine 218, and/or the DSP 220 to transmit credits to and/or receive credits from one or more of the credit manager 210, the convolution engine 214, the MMU 216, the RNN engine 218, the DSP 220, the memory 222, and/or the configuration controller 208. In addition, the CnC fabric 212 is configured to transmit example configure and control messages to and/or from the one or more selector(s). In other examples disclosed herein, any suitable computing fabric may be used to implement the CnC fabric 212 (e.g., an Advanced eXtensible Interface (AXI), etc.).

In the illustrated example of FIG. 2, the convolution engine 214 is coupled to the CnC fabric 212 and the data fabric 232. The convolution engine 214 is a device that is configured to improve the processing of tasks associated with convolution. Moreover, the convolution engine 214 improves the processing of tasks associated with the analysis of visual imagery and/or other tasks associated with CNNs.

In the illustrated example of FIG. 2, the example MMU 216 is coupled to the CnC fabric 212 and the data fabric 232. The MMU 216 is a device that includes references to all the addresses of the memory 222 and/or a memory that is remote with respect to the accelerator 206. The MMU 216 additionally translates virtual memory addresses utilized by one or more of the credit manager 210, the convolution engine 214, the RNN engine 218, and/or the DSP 220 to physical addresses in the memory 222 and/or the memory that is remote with respect to the accelerator 206.

In FIG. 2, the RNN engine 218 is coupled to the CnC fabric 212 and the data fabric 232. The RNN engine 218 is a device that is configured to improve the processing of tasks associated with RNNs. Additionally, the RNN engine 218 improves the processing of tasks associated with the analysis of unsegmented, connected handwriting recognition, speech recognition, and/or other tasks associated with RNNs.

In the example of FIG. 2, the DSP 220 is coupled to the CnC fabric 212 and the data fabric 232. The DSP 220 is a device that improves the processing of digital signals. For example, the DSP 220 facilitates the processing to measure, filter, and/or compress continuous real-world signals such as data from cameras, and/or other sensors related to computer vision.

In the example of FIG. 2, the memory 222 is coupled to the CnC fabric 212 and the data fabric 232. The memory 222 is a shared storage between at least one of the credit manager 210, the convolution engine 214, the MMU 216, the RNN engine 218, the DSP 220, and/or the configuration controller 208. The memory 222 includes the DMA unit 226. Additionally, the memory 222 can be partitioned into the one or more buffers 228 associated with one or more workload nodes of a workload associated with an executable received by the configuration controller 208 and/or the credit manager 210. Moreover, the DMA unit 226 of the memory 222 allows at least one of the credit manager 210 the convolution engine 214, the MMU 216, the RNN engine 218, the DSP 220, and/or the configuration controller 208 to access a memory (e.g., the system memory 102) remote to the accelerator 206 independent of a respective processor (e.g., the host processor 106). In the example of FIG. 2, the memory 222 is a physical storage local to the accelerator 206. Additionally or alternatively, in other examples, the memory 222 may be external to and/or otherwise be remote with respect to the accelerator 206. In further examples disclosed herein, the memory 222 may be a virtual storage. In the example of FIG. 2, the memory 222 is a non-volatile storage (e.g., ROM, PROM, EPROM, EEPROM, etc.). In other examples, the memory 222 may be a persistent BIOS or a flash storage. In further examples, the memory 222 may be a volatile memory.

In the illustrated example of FIG. 2, the kernel library 230 is a data structure that includes one or more kernels. The kernels of the kernel library 230 are, for example, routines compiled for high throughput on the DSP 220. In other examples disclosed herein, each CBB (e.g., any of the convolution engine 214, the MMU 216, the RNN engine 218, and/or the DSP 220) may include a respective kernel bank. The kernels correspond to, for example, executable sub-sections of an executable to be run on the accelerator 206. While, in the example of FIG. 2, the accelerator 206 implements a VPU and includes the credit manager 210, the CnC fabric 212, the convolution engine 214, the MMU 216, the RNN engine 218, the DSP 220, and the memory 222, and the configuration controller 208, the accelerator 206 may include additional or alternative CBBs to those illustrated in FIG. 2.

In the example of FIG. 2, the data fabric 232 is coupled to the credit manager 210, the convolution engine 214, the MMU 216, the RNN engine 218, the DSP 220, the memory 222, and the CnC fabric 212. The data fabric 232 is a network of wires and at least one logic circuit that allow one or more of the credit manager 210, the convolution engine 214, the MMU 216, the RNN engine 218, and/or the DSP 220 to exchange data. For example, the data fabric 232 allows a producer CBB to write tiles of data into buffers of a memory, such as the memory 222 and/or the memories located in one or more of the convolution engine 214, the MMU 216, the RNN engine 218, and the DSP 220. Additionally, the data fabric 232 allows a consuming CBB to read tiles of data from buffers of a memory, such as the memory 222 and/or the memories located in one or more of the convolution engine 214, the MMU 216, the RNN engine 218, and the DSP 220. The data fabric 232 transfers data to and from memory depending on the information provided in the package of data. For example, data can be transferred by methods of packets, wherein a packet includes a header, a payload, and a trailer. The header of a packet is the destination address of the data, the source address of the data, the type of protocol the data is being sent by, and a packet number. The payload is the data the a CBB produces or consumes. The data fabric 232 may facilitate the data exchange between CBBs based on the header of the packet by analyzing an intended destination address.

FIG. 3 is an example block diagram of the credit manager 210 of FIG. 2. In the example of FIG. 3, the credit manager 210 includes an example communication processor 302, an example credit generator 304, an example counter 306, an example source identifier 308, an example duplicator 310, and an example aggregator 312. The credit manager 210 is configured to communicate with the CnC fabric 212 and the data fabric 232 of FIG. 2 but may be configured to be coupled directly to different CBBs (e.g., the configuration controller 208, the convolution engine 214, the MMU 216, the RNN engine 218, and/or the DSP 220).

In the example of FIG. 3, the credit manager 210 includes the communication processor 302 coupled to the credit generator 304, the counter 306, the source identifier 308, the duplicator 310, and and/or the aggregator 312. The communication processor is hardware which performs actions based on received information. For example, the communication processor 302 provides instructions to at least each of the credit generator 304, the counter 306, the source identifier 308, the duplicator 310, and the aggregator 312 based on the data received by the configuration controller 208 of FIG. 2, such as configuration information. Such configuration information includes buffer characteristic information. For example, buffer characteristic information includes the size of the buffer, where the pointer is to point, the location of the buffer, etc. The communication processor 302 may package information, such as credits, to provide to a producer CBB and/or a consumer CBB. Additionally, the communication processor 302 controls where data is to be output to from the credit manager 210. For example, the communication processor 302 receives information, instructions, a notification, etc., from the credit generator 304 indicating credits are to be provided to the producer CBB.

In some examples, the communication processor 302 receives configuration information from a producing CBB. For example, during execution of a workload, a producing CBB determines the current slot of a buffer and provides a notification to the communication processor 302 for use in initializing the generating of a number of credits. In some examples, the communication processor 302 may communicate information between the credit generator 304, the counter 306, the source identifier 308, the duplicator 310, and/or the aggregator 312. For example, the communication processor 302 initiates the duplicator 310 or the aggregator 312 depending on the source identifier 308 identification. Additionally, the communication processor 302 receives information corresponding to a workload. For example, the communication processor 302 receives, via the CnC fabric 212, information determined by the compiler 204 and the configuration controller 208 indicative of the CBB initialized as the producer and the CBBs initialized as consumers. The example communication processor 302 of FIG. 3 may implement means for communicating.

In the example of FIG. 3, the credit manager 210 includes the credit generator 304 to generate a credit or a plurality of credits based on information received from the center fabric 212 of FIG. 2. For example, the credit generator 304 is initialized when the communication processor 302 receives information corresponding to the initialization of a buffer (e.g., the buffer 228 of FIG. 2). Such information may include a size and a number of slots of the buffer (e.g., storage size). The credit generator 304 generates n number of credits based on the n number of slots in the buffer. The n number of credits, therefore, are indicative of an available n number of spaces in a memory that a CBB can write to or read from. The credit generator 304 provides the n number of credits to the communication processor to package and send to a corresponding producer, determined by the configuration controller 208 of FIG. 2 and communicated over the CnC fabric 212. The example credit generator 304 of FIG. 3 may implement means for generating.

In the example of FIG. 3, the credit manager 210 includes the counter 306 to assist in controlling the amount of credits at each producer or consumer. For example, the counter 306 may include a plurality of counters where each of the plurality of counters are assigned to one producer and one or more consumers. A counter assigned to a producer (e.g., a producer credits counter) is controlled by the counter 306, where the counter 306 initializes a producer credits counter to zero when no credits are available for the producer. Further, the counter 306 increments the producer credits counter when the credit generator 304 generates credits for the corresponding producer. Additionally, the counter 306 decrements the producer credits counter when the producer uses a credit (e.g., when the producer writes data to a buffer such as the buffer 228 of FIG. 2). The counter 306 may initialize one or more consumer credits counters in a similar manner as the producer credits counters. Additionally and/or alternatively, the counter 306 may initialize internal counters of each CBB. For example, the counter 306 may be communicatively coupled to the example convolution engine 214, the example MMU 216, the example RNN engine 218, and the example DSP 220. In this manner, the counter 306 controls internal counters located at each one of the convolution engine 214, the MMU 216, the RNN engine 218, and/or the DSP 220.

In the example of FIG. 3, the credit manager 210 includes the source identifier 308 to identify where incoming credits originate from. For example, the source identifier 308, in response to the communication processor 302 receiving one or more credits over the CnC fabric 212, analyzes a message, an instruction, metadata, etc., to determine if the credit is from a producer or a consumer. The source identifier 308 may determine if the received credit is from the convolution engine 214 by analyzing the task or part of a task associated with the received credit and the convolution engine 214. In other examples, the source identifier 308 only identifies whether the credit was provided by a producer or a consumer by extracting information from the configuration controller 208. Additionally, when a CBB provides a credit to the CnC fabric 212, the CBB may provide a corresponding message or tag, such as a header, that identifies where the credit originates from. The source identifier 308 initializes the duplicator 310 or the aggregator 312, via the communication processor 302, based on where the received credit originated from. The example source identifier 308 of FIG. 3 may implement means for analyzing.

In the example FIG. 3, the credit manager 210 includes the duplicator 310 to multiply a credit by a factor of m, where m corresponds to a number of corresponding consumers. For example, m number of consumers was determined by the configuration controller 208 of FIG. 2 and provided in the configuration information when the workload was compiled as an executable. The communication processor 302 receives the information corresponding to the producer CBB and consumer CBBs and provides relevant information to the duplicator 310, such as how many consumers are consuming data from the buffer (e.g., the buffer 228 of FIG. 2). The source identifier 308 operates in a manner that controls the initialization of the duplicator 310. For example, when the source identifier 308 determines the source of a received credit is from a producer, the communicator processor 302 notifies the duplicator 310 a producer credit has been received and the consumer(s) may be provided with a credit. In this manner, the duplicator multiplies the one producer credit by m number of consumers in order to provide each consumer with one credit. For example, if there are two consumers, the duplicator 310 multiplies each received producer credit by 2, where one of the two credits is provided to the first consumer and the second of the two credits is provided to the second consumer. The example duplicator 310 of FIG. 3 may implement means for duplicating.

In the example of FIG. 3, the credit manager 210 includes the aggregator 312 to aggregate consumer credits to generate one producer credit. The aggregator 312 is initialized by the source identifier 308. The source identifier 308 determines when one or more consumers provide a credit to the credit manager 210 and initializes the aggregator 312. In some examples, the aggregator 312 is not notified to aggregate credits until each consumer has utilized a credit corresponding to the same available space in the buffer. For example, if two consumers each have one credit for reading data from a first space in a buffer and only the first consumer has utilized the credit (e.g., consumed/read data from the first space in the buffer), the aggregator 312 will not be initialized. Further, the aggregator 312 will be initialized when the second consumer utilizes the credit (e.g., consumes/reads the data from the first space in the buffer). In this manner, the aggregator 312 combines the two credits into a single credit and provides the credit to the communicator processor 302 for transmitting to the producer.

In examples disclosed herein, the aggregator 312 waits to receive all the credits for a single space in a buffer because the space in the buffer is not obsolete until the data of that space in the buffer has been consumed by all appropriate consumers. The consumption of data is determined by the workload such that the workload decides what CBB must consume data in order to execute the workload in the intended manner. In this manner, the aggregator 312 queries the counter 306 to determine when to combine the multiple returned credits into the single producer credit. For example, the counter 306 may control a slot credits counter. The slots credit counter may be indicative of a number of credits corresponding to a slot in the buffer. If the slot credits counter equals the m number of consumers of the workload, the aggregator 312 may combine the credits to generate the single producer credit. Additionally, in some examples, when execution of a workload is complete, the producer may have extra credits not used. In this manner, the aggregator 312 zeros credits at the producer by removing the extra credits from the producer. The example aggregator 312 of FIG. 3 may implement means for aggregating.

While an example manner of implementing the credit manager of FIG. 2 is illustrated in FIG. 3, one or more of the elements, processes and/or devices illustrated in FIG. 3 may be combined, divided, re-arranged, omitted, eliminated and/or implemented in any other way. Further, the example communication processor 302, the example credit generator 304, the example counter 306, the example source identifier 308, the example duplicator 310, the example aggregator 312, and/or, more generally, the example credit manager 210 of FIG. 2 may be implemented by hardware, software, firmware and/or any combination of hardware, software and/or firmware. Thus, for example, any of the example communication processor 302, the example credit generator 304, the example counter 306, the example source identifier 308, the example duplicator 310, the example aggregator 312 and/or, more generally, the example credit manager 210 could be implemented by one or more analog or digital circuit(s), logic circuits, programmable processor(s), programmable controller(s), graphics processing unit(s) (GPU(s)), DSP(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communication processor 302, the example credit generator 304, the example counter 306, the example source identifier 308, the example duplicator 310, and/or the example aggregator 312 is/are hereby expressly defined to include a non-transitory computer readable storage device or storage disk such as a memory, a digital versatile disk (DVD), a compact disk (CD), a Blu-ray disk, etc. including the software and/or firmware. Further still, the example credit manager 210 of FIG. 2 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

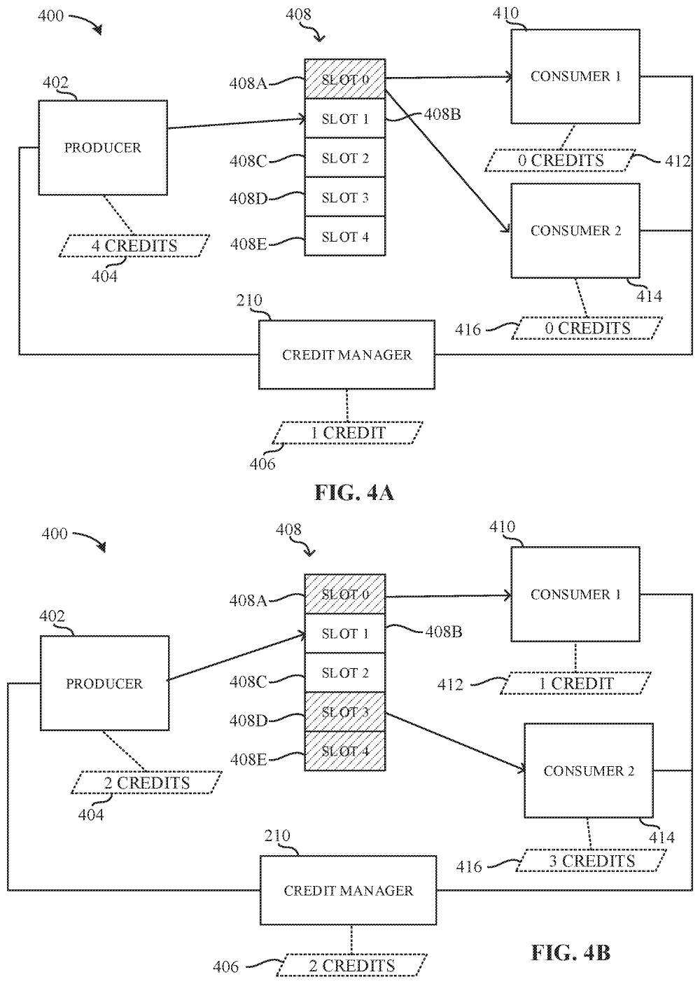

FIGS. 4A and 4B are block diagrams illustrating an example operation 400 of the flow of credits between producer and consumers. FIGS. 4A and 4B includes the example credit manager 210, an example producer 402, an example buffer 408, an example first consumer 410, and an example second consumer 414.

Turning to FIG. 4A, the example operation 400 includes the producer 402 to produce a stream of data for the first consumer 410 and the second consumer 414. The producer 402 may be at least one of the convolution engine 214, the MMU 216, the RNN engine 218, the DSP 220, and/or any other CBB located internally or externally to the accelerator 206 of FIG. 2. The producer 402 is determined by the configuration controller 208 to have producer nodes, which are nodes that produce data to be executed by a consumer node. The producer 402 partitions a data stream into a small quanta called “tiles” that fit into a slot of the buffer 408. For example, the data stream is partitioned and stored into the buffer 408 in order of production, such that the beginning of the data stream is to be partitioned and stored first and then so on as the process continues chronologically. A “tile” of data is a packet of data packaged into pre-defined multi-dimensional blocks of data elements for transfer over the data fabric 232 of FIG. 2. The producer 402 includes a respective producer credits counter 404 to count credits provided by the credit manager 210. In some examples, the producer credits counter 404 is an internal digital logic device located inside the producer 402. In other examples, the producer credits counter 404 is an external digital logic device located in the credit manager 210 and associated with the producer 402.

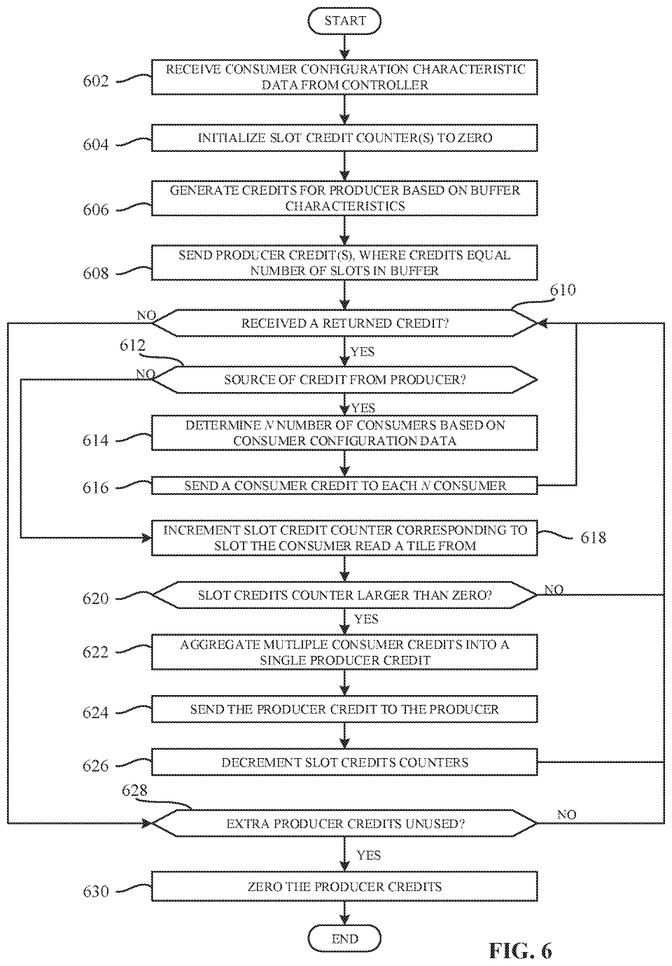

In FIG. 4A, the example operation 400 includes the credit manager 210 to communicate between the producer 402 and first and second consumers 410, 414. The credit manager 210 includes a respective credit manager counter 406 which counts credits received from either the producer 402 or the first and second consumer 410, 414. The credit manager 210 is coupled to the producer 402, the first consumer 410, and the second consumer 414. The operation of the credit manager 210 is described in further detail below in connection with FIG. 6.

In FIG. 4A, the example operation 400 includes the buffer 408 to store data produced by the producer 402 and be accessible by a plurality of consumers such as the first and second consumer 410, 414. The buffer 408 is a cyclic buffer illustrated as an array. The buffer 408 includes respective slots 408A-408E. A slot in a buffer is a fixed value size of storage space in the buffer 408, such as an index in an array. The size of the buffer 408 is configured per stream of data. For example, the buffer 408 may be configured by the configuration controller 208 such that the current data stream can be produced into the buffer 408. The buffer 408 may be configured to include more than the respective slots 408A-408E. For example, the buffer 408 may be configured by the configuration controller 208 to include 16 slots. The configuration controller 208 may also configure the size of the slots in the buffer 408 based on executables compiled by the compiler 204. For example, the respective ones of slots 408A-408E may be a size that can fit one tile of data for storage. In the example of FIG. 4A, the slots represented with slanted lines are indicative of filled space, such that the producer 402 wrote data (e.g., stored the tile) into the slot. In the example of FIG. 4A, the slots represented without slanted lines are indicative of empty space (e.g., available space), such that the producer 402 can write data into the slot. For example, slot 408A is a produced slot and 408B-408E are available slots.

In examples disclosed herein, each buffer (e.g., the buffer 228 of FIG. 2, the buffer 408, or any other buffer located in an available or accessible memory) includes pointers. A pointer points to an index (e.g., a slot) containing an available space to be written to or points to an index containing a data (e.g., a record) to be processed. In some examples, there are write pointers and there are read pointers. The write pointer corresponds to the producer 402 to inform the producer 402 where the next available slot to produce data is. The read pointers correspond to the consumers (e.g., first consumer 410 and second consumer 414) and follow the write pointers in chronological order of storage and buffer slot number. For example, if a slot is empty, the read pointer will not point the consumer to that slot. Instead, the read pointer will wait until a write pointer has moved from a slot that has been written to and will point to the now-filled slot. In FIG. 4A, the pointers are illustrated as arrows connecting the producer 402 to the buffer 408 and the buffer 408 to the first consumer 410 and the second consumer 414.

In FIG. 4A, the example operation 400 includes the first consumer 410 and the second consumer 414 to read data from the buffer 408. The first consumer 410 and the second consumer 414 may be any of the convolution engine 214, the MMU 216, the RNN engine 218, the DSP 220, and/or any other CBB located internally or externally to the accelerator 206 of FIG. 2. The consumers 410, 414 are determined by the configuration controller 208 to have consumer nodes which are nodes that consume data for processing and execution of a workload. In the illustrated example, the consumers 410, 414 are configured to each consume the data stream produced by the producer 402. For example, the first consumer 410 is to operate on the executable task identified in the data stream and the second consumer 414 is to operate on the same executable task identified in the data stream, such that both the first consumer 410 and the second consumer 414 perform in the same manner.

In examples disclosed herein, the first consumer 410 includes a first consumer credits counter 412 and the second consumer 414 includes a second consumer credits counter 416. The first and second consumer credits counters 412, 416 count credits provided by the credit manager 210. In some examples, the first and second consumer credits counters 412, 416 are internal digital logic devices included in the first and second consumer 410, 414. In other examples, the first and second consumer credits counters 412, 416 are external digital logic devices located in the credit manager 210 at the counter 306 and associated with the consumers 410, 414.

In FIG. 4A, the example operation 400 begins when the producer 402 determines, from configuration control messages, the buffer 408 is to have five slots. Concurrently, the configuration control messages from the configuration controller 208 indicate the size of the buffer to the credit manager 210, and the credit manager 210 generates 5 credits for the producer 402. Such buffer characteristics may be configuration characteristics, configuration information, etc., received from the configuration controller 208 of FIG. 2. For example, the credit generator 304 of FIG. 3 generates n number of credits, where n equals the number of slots in the buffer 408. When the producer 402 is provided with the credits, the producer credits counter 404 is incremented to equal the number of credits received (e.g., 5 credits total). In the illustrated example of FIG. 4A, the producer 402 has produced (e.g., written) data to first slot 408A. In this manner, the producer credits counter 404 decremented by one (e.g., now indicative of 4 credits because one credit was used to produce data into the first slot 408A), the credit manager counter 406 incremented by one (e.g., the producer provided the used credit back to the credit manager 210), the write pointer moved to second slot 408B, and the read pointers are pointing from first slot 408A. The first slot 408A is currently available to consume (e.g., read) data from by the first consumer 410 and/or the second consumer 414.

Turning to FIG. 4B, the illustrated example of operation 400 illustrates how credits are handed out by the credit manager 210. In some examples, FIG. 4B illustrates operation 400 after credits have already been generated by the credit generator 304 of the credit manager 210. In the illustrated operation 400 of FIG. 4B, the producer credits counter 404 equals 2, the credit manager counter 406 equal 2, the first consumer credits counter 412 equal 1, and the second consumer credits counter 416 equals 3.

The producer 402 has 2 credits because there are three slots (e.g., first slot 408A, fourth slot 408D, and fifth slot 408E) filled and only 2 slots available to fill (e.g., write or produce to). The first consumer 410 has 1 credit because the first consumer 410 consumed the tiles in the fourth slot 408D and the fifth slot 408E. In this manner, there is only one more slot (e.g., first slot 408A) for the first consumer 410 to read from. The second consumer 414 has 3 credits because after the producer filled three slots, the credit manager 210 provided both the first consumer 410 and the second consumer 414 with 3 credits each in order to access and consume 3 tiles from the three slots (e.g., first slot 408A, fourth slot 408D, and fifth slot 408E). In the illustrated example, the second consumer 414 has not consumed any tiles from the buffer 408. In this manner, the second consumer 414 may be slower than first consumer 410 such that the second consumer 414 reads data at a lower bit-per-minute than the first consumer 410.

In the illustrated example of FIG. 4B, the credit manager 210 has 2 credits because the first consumer 410 gave away the 2 credits the first consumer 410 used after reading the tiles from fourth slot 408D and fifth slot 408E. The credit manager 210 will not pass credits to the producer 402 until each consumer has consumed the tile from each slot. For example, when the second consumer 414 consumes the fourth slot 408D, the second consumer 414 may send a credit to the credit manager corresponding to the slot and the credit manager 210 will aggregate the credit from the first consumer 410 (e.g., the credit already sent by the first consumer 410 after the first consumer 410 consumed a tile in the fourth slot 408D) with the credit from the second consumer 414. Further, the credit manager 210 provides the aggregated credit to the producer 402 to indicate fourth slot 408D is available to produce to. The operation 400 of passing credits between producer (e.g., producer 402) and consumers (e.g., 410, 414) may continue until the producer 402 has produced the entire data stream and the consumers 410, 414 have executed the executable in the data stream. The consumers 410, 414 may not execute a task until the consumers 410, 414 have consumed (e.g., read) all the data offered in the data stream.

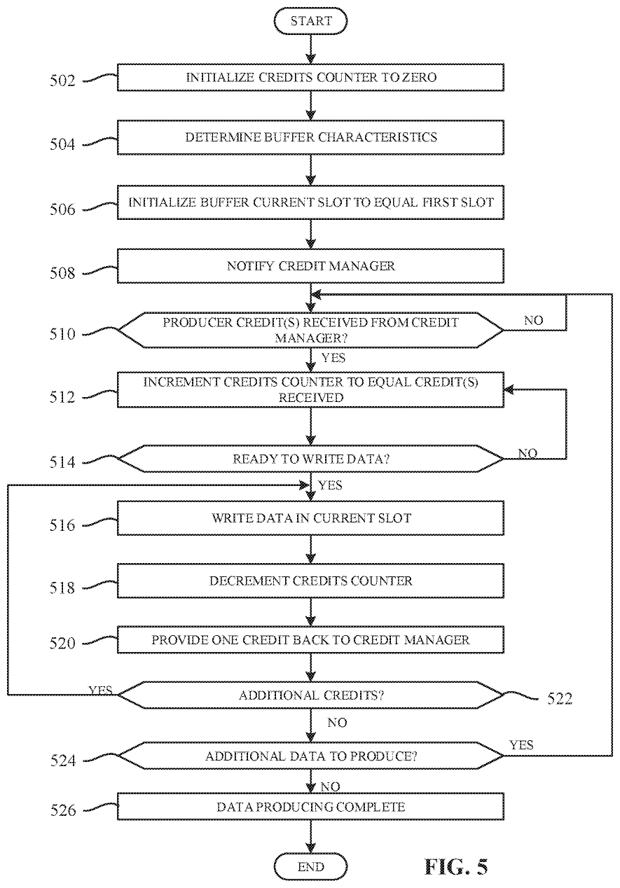

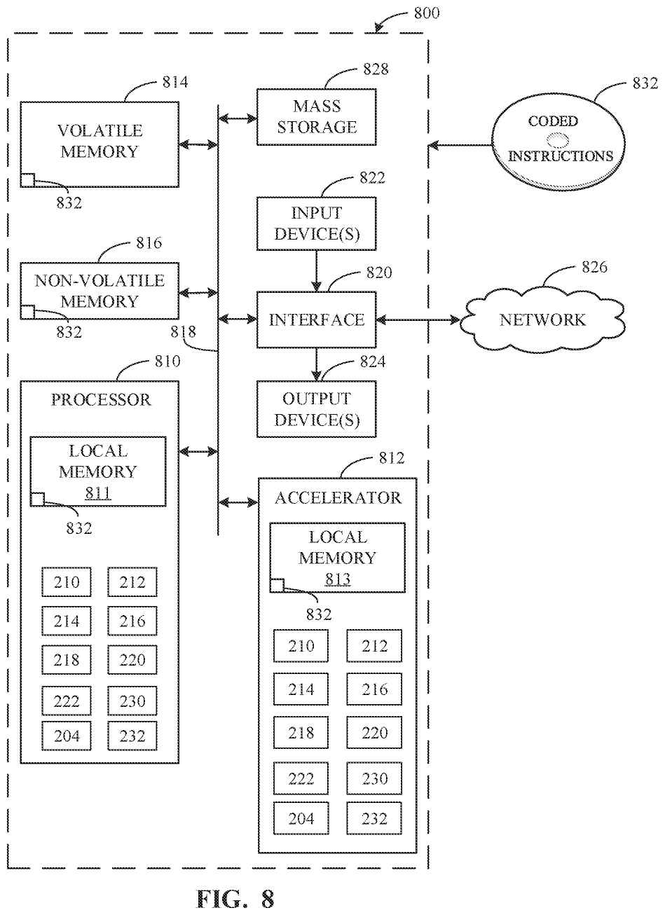

Flowcharts representative of example hardware logic, machine readable instructions, hardware implemented state machines, and/or any combination thereof for implementing the credit manager 210 of FIG. 3 are shown in FIGS. 5-7. The machine readable instructions may be one or more executable programs or portion(s) of an executable program for execution by a computer processor such as the processor 810 and/or the accelerator 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 810, but the entire program and/or parts thereof could alternatively be executed by a device other than the processor 810 and/or embodied in firmware or dedicated hardware. Further, although the example program is described with reference to the flowcharts illustrated in FIGS. 5-7, many other methods of implementing the example may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein. In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

As mentioned above, the example processes of FIGS. 5-7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B. and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program of FIG. 5 is a flowchart representative of machine readable instructions which may be executed to implement an example producing CBB (e.g., the producer 402) of FIGS. 4A and/or 4B. The example producer 402 may be any one of the convolution engine 214, the MMU 216, the RNN engine 218, the DSP 220, and/or any suitable CBB of the accelerator 206 of FIG. 2, configured by the configuration controller 208 to produce data streams indicative of tasks for a consumer to operate. The program of FIG. 5 begins when the producer 402 initializes the producer credits counter to zero (block 502). For example, in the illustrated examples of FIGS. 4A and 4B, the producer credits counter 404 may be a digital logic device located inside of the producer 402 and controlled by the credit manager 210 (FIG. 2) or the producer credits counter 404 may be located external to the producer 402 such that the producer credits counter 404 is located at the counter 306 of the credit manager 210.

The example producer 402 determines a buffer (block 504) (e.g., the buffer 228 of FIG. 2, the buffer 408 of FIGS. 4A and 4B, or any suitable buffer located in a general purpose memory) by receiving configuration control messages from the configuration controller 208. For example, the configuration control messages inform the producer that the buffer is x number of slots, the pointer starts at the first slot, etc. In this manner, the producer partitions a data stream into tiles and the tiles are equal to the size the of slots in the buffer, such that the slots are to store the tiles. Additionally, the producer 402 initializes the buffer current slot to equal the first slot (block 508). For example, the producer 402 determines where the write pointer will point to first in the buffer. A buffer is written and read to in an order, such as a chronological order. The current slot in the buffer is to be initialized by the producer 402 as the oldest slot and work through the buffer from oldest to newest, where the newest slot is the most recent slot written to.

In response to the producer 402 initializing the buffer current slot to equal first slot (block 506), the producer 402 provides a notification to the credit manager 210 (block 508) over the configuration controller 208 (FIG. 2). For example, the producer 402 notifies the credit manager 210 that the producer 402 has completed determining buffer characteristics.

When the write pointer is initialized and the credit manager 210 has been notified, the producer 402 waits to receive credits from the credit manager 210 (block 510). For example, in response to the producer 402 notifying the credit manager 210, the credit manager 210 may generate n number of credits and provide them back to the producer 402. In some examples, the credit manager 210 receives the configuration control messages from the configuration controller 208 corresponding to the buffer size and location.

If the producer 402 does not receive credits from the credit manager 210 (e.g., block 510 returns a NO), the producer 402 waits until the credit manager 210 provides the credits. For example, the producer 402 cannot perform an assigned task until credits are given because the producer 402 does not have access to the buffer until a credit verifies the producer 402 does have access. If the producer 402 does receive credits from the credit manager 210 (e.g., block 510 returns a YES), the producer credits counter increments to equal the credits received (block 512). For example, the producer credits counter may increment by one until the producer credits counter equals n number of received credits.

The producer 402 determines if the data stream is ready to be written to the buffer (e.g., block 514). For example, if the producer 402 has not yet partitioned and packaged tiles for production or the producer credits counter has not received a correct number of credits (e.g., block 514 retums a NO) then control returns to block 512. If the example producer 402 has partitioned and packaged tiles of the data stream for production (e.g., block 514 returns a YES), then the producer 402 writes data to current slot (block 516). For example, the producer 402 stores data into the current slot indicated by the write pointer and originally initialized by the producer 402.

In response to the producer 402 writing data into the current slot (block 516), the producer credits counter is decremented (block 518). For example, the producer 402 may decrement the producer credits counter and/or the credit manager 210 may decrement the producer credits counter. In this example, the producer 402 provides one credit back to the credit manager 210 (block 520). For example, the producer 402 utilizes a credit and the producer 402 passes the credit for use by a consumer.

The producer 402 determines if the producer 402 has any more credits to use (block 522). If the producer 402 determines there are additional credits (e.g., block 522 returns a YES), control returns to block 516. If the producer 402 determines the producer 402 does not have additional credits to use (e.g., block 522 returns a NO) but still includes data to produce (e.g., block 524 returns a YES), the producer 402 waits to receive credits from the credit manager 210 (e.g., control returns to block 510). For example, the consumers may not have consumed tiles produced by the producer 402 and therefore, there are no available slots in the buffer to write to. If the producer 402 does not have additional data to produce (e.g., block 524 returns a NO), then data producing is complete (block 526). For example, the data stream has been fully produced into the buffer and consumed by the consumers. The program of FIG. 5 may be repeated when a producer 402 produces another data stream for one or more consumers.

FIG. 6 is a flowchart representative of machine readable instructions which may be executed to implement the example credit manager of FIGS. 2, 3, 4A, and/or 4B. The program of FIG. 6 begins when the credit manager 210 receives consumer configuration characteristic data from the configuration controller 208 (FIG. 2) (block 602). For example, the configuration controller 208 communicates information corresponding to the CBBs that are processing data of an input 202 (e.g., workload) and the CBBs that are producing the data for processing. The configuration controller 208 communicates messages to the communication processor 302 (FIG. 3) of the credit manager 210.

In the example program of FIG. 6, the counter 306 (FIG. 3) initializes the slot credits counter to zero (block 604). For example, the slot credits counter is indicative of a number of credits corresponding to a single slot and multiple consumers, such that there is a counter for each slot in the buffer. The number of slot credits counters initialized by the counter 306 corresponds to the number of slots in a buffer (e.g., the number of tiles of data the buffer can store). For example, if there are 500 slots in the buffer, the counters 306 will initialize 500 slot credits counters. In operation, each of the slot credits counters counts the number of consumers that have read from a slot. For example, if slot 250 of a 500 slot buffer is being read by one or more consumers, the slot credits counter corresponding to slot 250 can be incremented by the counter 306 for each of the one or more consumers that reads from the slot. Moreover, if there are 3 consumers in the workload and each consumer is configured to read from slot 250 of the 500 slot buffer, the slot credits counter corresponding to slot 250 increments to three. Once the slot credits counter corresponding to slot 250 of the 500 slot buffer increments to three, the counter 306 resets and/or otherwise clears the slot credits counter corresponding to slot 250 of the 500 slot buffer to zero.

Additionally, the slot credits counter assists the aggregator 312 in determining when each consumer 410, 414 has read the tile stored in the slot. For example, if there are 3 consumers who are to read a tile from a slot in the buffer, the slot credits counter will increment up to 3, and when the slot credits counter equals 3, the aggregator 312 may combine the credits to generate a single producer 402 credit for that one slot.

The communication processor 302 notifies the credit generator 304 to generate credits for the producer 402 based on received buffer characteristics (block 606). The credit generator 304 generates corresponding credits. For example, the communication processor 302 receives information from the configuration controller 208 corresponding to buffer characteristics and additionally receives a notification that the producer 402 initialized a pointer.

In response to the credit generator 304 generating credits (block 606), the communication processor 302 packages the credits and sends the producer 402 credits, where the producer credits equal the number of slots in the buffer (block 608). For example, the credit generator 304 may specifically generate credits for the producer 402 (e.g., producer credits) because the buffer is initially empty and may be filled by the producer 402 when credits become available. Additionally, the credit generator 304 generates n number of credits for the producer 402, such that n equals a number of slots in the buffer available for the producer 402 to write to.

The credit manager 210 waits to receive a returned credit (block 610). For example, when the producer 402 writes to a slot in a buffer, a credit corresponding to that slot is returned to the credit manager 210. When the credit manager 210 does not receive a returned credit (e.g., block 610 returns a NO), the credit manager 210 waits until a credit is provided back. When the credit manager 210 receives a returned credit (e.g., block 610 returns a YES), the communication processor 302 provides the credit to the source identifier 308 to identify the source of the credit (block 612). For example, the source identifier 308 may analyze a package corresponding to the returned credit that includes a header. The header of the package may be indicative of where the package was sent from, such that the package was sent from a CBB assigned as a producer 402 or consumer 410, 414.

Further, the source identifier 308 determines if the source of the credit was from the producer 402 or at least one of the consumers 410, 414. If the source identifier 308 determines the source of the credit was from the producer 402 (e.g., block 612 returns a YES), source identifier 308 initializes the duplicator 310 (FIG. 3) via the communication processor 302 to determine m number of consumers based on the received consumer configuration data from the configuration controller 208 (block 614). For example, the duplicator 310 is initialized to multiply a producer credit so that each consumer 410, 414 in the workload receives a credit. In some examples, there is one consumer per producer 402. In other examples, there are a plurality of consumers 410, 414 per one producer 402, each of whom are to consume, and process data produced by the producer 402.

In response to the duplicator 310 multiplying credits for each m number of consumers 410, 414, the communication processor 302 packages the credits and send a consumer credit to m consumers 410, 414 (block 616). Control returns to block 610 until the credit manager 210 does not receive a returned credit.

In the example program of FIG. 6, if the source identifier 308 identifies the source of the credit is a consumer 410, 414 (e.g., block 612 returns a NO), the counter 306 increments a slot credits counter assigned to the slot that the at least one of the consumers 410, 414 read a tile from (block 618). For example, the counter 306 keeps track of the consumer credits in order to determine when to initialize the aggregator 312 (FIG. 3) to combine consumer credits. In this manner, the counter 306 does not increment the consumer credits counter (e.g., such as the consumer credits counter 412 and 416) because the consumer credits counter is associated with the number of credits at least one of the consumers 410, 414 possesses. Instead, the counter 306 increments a counter corresponding to a number of credits received by the credit manager 210 from one or more consumers 410, 414 corresponding to a specific slot.

In response to the counter 306 incrementing a counter assigned to one of the consumers 410, 414 who returned the credit, the aggregator 312 queries the counter assigned to one of the consumers 410, 414 to determine if the slot credits counter is greater than zero (block 620). If the counter 306 notifies the aggregator 312 the slot credits counter is not greater than zero (e.g., block 620 returns a NO), control returns to block 610. If the counter 306 notifies the aggregator 312 the slot credits counter is greater than zero (e.g., block 620 returns a YES), the aggregator 312 multiplies consumer credits into a single producer credit (block 622). For example, the aggregator 312 is informed by the counter 306, via the communication processor 302, that one or more credits have been returned by one or more consumers. In some examples, the aggregator 312 analyzes the returned credit to determine the slot the credit was used to consume by one of the consumers 410, 414.

In response to the aggregator 312 combining consumer credits, the communication processor 302 packages the credit and send the credit to the producer 402 (block 624). For example, the aggregator 312 passes the credit to the communication processor 302 for packaging and transmitting the credit over the CnC fabric 212 to the intended CBB. In response to the communication processor 302 sending a credit to the producer 402, the counter 306 decrements the slot credits counter (block 626) and control returns to block 610.

At block 610, the credit manager 210 waits to receive a returned credit. When the credit manager 210 does not receive a returned credit after a threshold amount of time (e.g., block 610 returns a NO), the credit manager 210 checks for extra producer credits that are unused (block 628). For example, if the credit manager 210 is not receiving returned credits from the producer 402 or the consumers 410, 414, the data stream is fully consumed and has been executed by the consumers 410, 414. In some examples, a producer 402 may have unused credits left over from production, such as credits that were not needed to produce the last few tiles into the buffer. In this manner, the credit manager 210 zeros the producer credits (block 630). For example, the credit generator 304 removes credits from the producer 402 and the counter 306 decrements the producer credits counter (e.g., producer credits counter 404) until the producer credits counter equals zero.

The program of FIG. 6 ends when no credits are left for a workload, such that the credit manager 210 is not operating to communicate between a producer 402 and multiple consumers 410, 414. The program of FIG. 6 can repeat when a CBB, initialized as a producer 402, provides buffer characteristics to the credit manager 210. In this manner, the credit generator 304 generates credits for the initiating of production and consumption between CBBs to execute a workload.

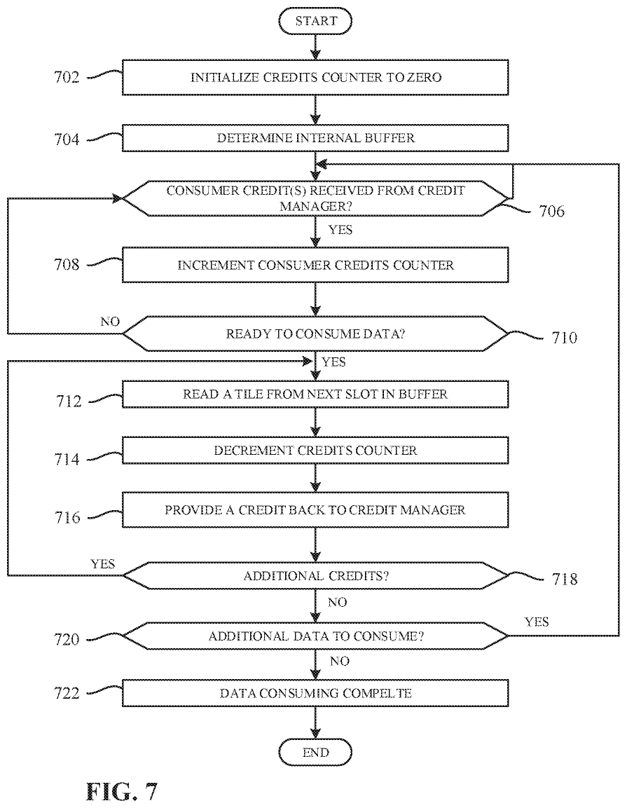

FIG. 7 is a flowchart representative of machine readable instructions which may be executed to implement one or more of the example consuming CBBs (e.g., first consumer 410 and/or second consumer 414) of FIGS. 4A and/or 4B. The program of FIG. 7 begins when the consumer credits counter (e.g., the consumer credits counter 412, 416) initializes to zero (block 702). For example, the counter 306 of the credit manager 210 may control a digital logic device associated with at least one of the consumers 410, 414 that is indicative of a number of credits at least one of the consumers 410, 414 can use to read data from a buffer.

The at least one of the consumers 410, 414 further determines an internal buffer (block 604). For example, the configuration controller 208 sends messages and control signals to CBBs (e.g., any one of the convolution engine 214, the MMU 216, the RNN engine 218, and/or the DSP 220) informing the CBBs of a configuration mode. In this manner, the CBB is configured to be a consumer, 410 or 414, with an internal buffer for storing data produced by a different CBB (e.g., a producer).

After determining of the internal buffers (block 704) are complete, the consumers 410, 414 wait to receive consumer credits from the credit manager 210 (block 706). For example, the communication processor 302 of the credit manager 210 provides the consumers 410, 414 a credit after the producer 402 has used the credit for writing data in the buffer. If the consumers 410, 414 receive a credit from the credit manager (e.g., block 706 returns a YES), the counter 306 increments the consumer credits counter (block 708). For example, the consumer credits counter is incremented by a number of credits the credit manager 210 passes to the consumers 410, 414.

In response to receiving a credit/credits from the credit manager 210, the consumers 410, 414 determine if they are ready to consume data (block 710). For example, the consumers 410, 414 can read data from a buffer when initialization is complete and when there are enough credits available for the consumers 410, 414 to access the data in the buffer. If the consumers 410, 414 are not ready to consume data (e.g., block 710 returns a NO), control returns to block 706.

If the consumers 410, 414 are ready to consume data from the buffer (e.g., block 710 returns a YES), the consumers 410, 414 read a tile from the next slot in the buffer (block 712). For example, a read pointer is initialized after the producer 402 writes data to a slot in the buffer. In some examples, the read pointer follows the write pointer in order of production. When the consumers 410, 414 read data from a slot, the read pointer moves to the next slot produced by the producer 402.

In response to reading a tile from the next slot in the buffer (block 712), the counter 306 decrements the consumer credits counter (block 714). For example, a credit is used each time the consumer consumes (e.g., reads) a tile from a slot in a buffer. Therefore, the consumer credits counter decrements and concurrently, the consumers 410, 414 send a credit back to the credit manager 210 (block 716). The consumer checks if there are additional credits available for the consumers 410, 414 to use (block 718). If there are additional credits for the consumers 410, 414 to use (e.g., block 718 returns a YES), control returns to block 712. For example, the consumers 410, 414 continue to read data from the buffer.

If there are no additional credits for the consumers 410, 414 to use (e.g., block 718 returns a NO), the consumers 410, 414 determine if additional data is to be consumed (block 720). For example, if the consumers 410, 414 do not have enough data to execute a workload, then there is additional data to consume (e.g., block 720 returns a YES). In this manner, control returns to block 706 where the consumers 410, 414 wait for a credit. If the consumers 410, 414 have enough data to execute an executable compiled by the compiler 204, then there is no additional data to consume (e.g., block 720 returns a NO), then data consuming is complete (block 722). For example, the consumers 410, 414 read the whole data stream produced by the producer 402.

The program of FIG. 7 ends when the executable is executed by the consumers 410, 414. The program of FIG. 7 may repeat when the configuration controller 208 configures CBBs to execute another workload, compiled as an executable by an input (e.g., such as input 202 of FIG. 2).

FIG. 8 is a block diagram of an example processor platform 800 structured to execute the instructions of FIGS. 5-7 to implement the credit manager 210 of FIGS. 2-3. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 810 and an accelerator 812. The processor 810 of the illustrated example is hardware. For example, the processor 810 can be implemented by one or more integrated circuits, logic circuits, microprocessors, GPUs, DSPs, or controllers from any desired family or manufacturer. The hardware processor may be a semiconductor based (e.g., silicon based) device. Additionally, the accelerator 812 can be implemented by, for example, one or more integrated circuits, logic circuits, microprocessors, GPUs, DSPs, FPGAs, VPUs, controllers, and/or other CBBs from any desired family or manufacturer. The accelerator 812 of the illustrated example is hardware. The hardware accelerator may be a semiconductor based (e.g., silicon based) device. In this example, the accelerator 812 implements the example credit manager 210, the example CnC fabric 212, the example convolution engine 214, the example MMU 216, the example RNN engine 218, the example DSP 220, the example memory 222, the example configuration controller 208, the example kernel bank 230, and/or the example data fabric 232. In this example, the processor 810 may implement the example credit manager 210 of FIGS. 2 and/or 3, the example compiler 204, the example configuration controller 208, the example credit manager 210, the example the example CnC fabric 212, the example convolution engine 214, the example MMU 216, the example RNN engine 218, the example DSP 220, the example memory 222, the example kernel bank 230, the example data fabric 232, and/or, more generally, the example accelerator 206 of FIG. 2.

The processor 810 of the illustrated example includes a local memory 811 (e.g., a cache). The processor 810 of the illustrated example is in communication with a main memory including a volatile memory 814 and a non-volatile memory 816 via a bus 818. Moreover, the accelerator 812 of the illustrated example includes a local memory 813 (e.g., a cache). The accelerator 812 of the illustrated example is in communication with a main memory including the volatile memory 814 and the non-volatile memory 816 via the bus 818. The volatile memory 814 may be implemented by Synchronous Dynamic Random Access Memory (SDRAM), Dynamic Random Access Memory (DRAM), RAMBUS' Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5, 6, and/or 7 may be stored in the mass storage device 828, in the volatile memory 814, in the non-volatile memory 816, and/or on a removable non-transitory computer readable storage medium such as a CD or DVD.

Example methods, apparatus, systems, and articles of manufacture for multiple asynchronous consumers are disclosed herein. Further examples and combinations thereof include the following:

Example 1 includes an apparatus comprising a communication processor to receive configuration information from a producing compute building block, a credit generator to generate a number of credits for the producing compute building block corresponding to the configuration information, the configuration information including characteristics of a buffer, a source identifier to analyze a returned credit to determine whether the returned credit originates from the producing compute building block or a consuming compute building block, and a duplicator to, when the returned credit originates from the producing compute building block, multiply the returned credit by a first factor, the first factor indicative of a number of consuming compute building blocks identified in the configuration information.

Example 2 includes the apparatus of example 1, wherein the producing compute building block is to produce a stream of data for one or more consuming compute building blocks to operate on.

Example 3 includes the apparatus of example 1, further including an aggregator to, when the source identifier identifies the returned credit originates from the consuming compute building block, combine multiple returned credits from a number of consuming compute building blocks corresponding to the first factor into a single producer credit.

Example 4 includes the apparatus of example 3, wherein the aggregator is to query a counter to determine when to combine the multiple returned credits into the single producer credit, the counter is to increment each time a credit corresponding to a location in a memory is returned.

Example 5 includes the apparatus of example 4, wherein a producing compute building block cannot receive the single producer credit until each of the number of consuming compute building blocks corresponding to the first factor have returned a credit.

Example 6 includes the apparatus of example 1, wherein the communication processor is to send a credit to each of the number of consuming compute building blocks.

Example 7 includes the apparatus of example 1, wherein the producing compute building block is to determine a size of the buffer, the buffer to have a number of slots corresponding to a second factor for storing data produced by the producing compute building block.

Example 8 includes the apparatus of example 1, wherein the configuration information identifies the number of consuming compute building blocks per single producing compute building block.

Example 9 includes a non-transitory computer readable storage medium comprising instructions that, when executed, cause a processor to at least receive configuration information from a producing compute building block, generate a number of credits for the producing compute building block corresponding to the configuration information, the configuration information including characteristics of a buffer, analyze a returned credit to determine whether the returned credit originates from the producing compute building block or a consuming compute building block, and when the returned credit originates from the producing compute building block, multiply the returned credit by a first factor indicative of a number of consuming compute building blocks identified in the configuration information.

Example 10 includes the non-transitory computer readable storage medium as defined in example 9, wherein the instructions, when executed, cause the processor to produce a stream of data for one or more consuming compute building blocks to operate on.

Example 11 includes the non-transitory computer readable storage medium as defined in example 9, wherein the instructions, when executed, cause the processor to, when the returned credit originates from the consuming compute building block, combine multiple returned credits from the number of consuming compute building blocks corresponding to the first factor into a single producer credit.

Example 12 includes the non-transitory computer readable storage medium as defined in example 11, wherein the instructions, when executed, cause the processor to query a counter to determine when to combine the multiple returned credits into the single producer credit, the counter to increment each time a credit corresponding to a location in a memory is returned.

Example 13 includes the non-transitory computer readable storage medium as defined in example 12, wherein the instructions, when executed, cause the processor to not provide the producing compute building block the single producer credit until each of the number of consuming compute building blocks corresponding to the first factor have returned a credit.

Example 14 includes the non-transitory computer readable storage medium as defined in example 9, wherein the instructions, when executed, cause the processor to send a credit to each of the number of consuming compute building blocks.

Example 15 includes the non-transitory computer readable storage medium as defined in example 9, wherein the instructions, when executed, cause the processor to determine the number of consuming compute building blocks per single producing compute building block based on the configuration information.

Example 16 includes a method comprising receiving configuration information from a producing compute building block, generating a number of credits for the producing compute building block corresponding to the configuration information, the configuration information including characteristics of a buffer, analyzing a returned credit to determine whether the returned credit originates from the producing compute building block or a consuming compute building block, and when the returned credit originates from the producing compute building block, multiplying the returned credit by a first factor is the first factor indicative of a number of consuming compute building blocks identified in the configuration information.

Example 17 includes the method of example 16, further including combining multiple returned credits from the number of consuming compute building blocks corresponding to the first factor into a single producer credit when the returned credit originates from the consuming compute building block.

Example 18 includes the method of example 17, further including querying a counter to determine when to combine the multiple returned credits into the single producer credit, the counter to increment each time a credit corresponding to a location in a memory is returned.

Example 19 includes the method of example 18, further including waiting to provide the producing compute building block the single producer credit until each of the number of consuming compute building blocks have returned a credit.

Example 20 includes the method of example 16, further including sending a credit to each of the number of consuming compute building blocks corresponding to the first factor.

Example 21 includes an apparatus comprising means for communicating, the means for communicating to receive configuration information from a producing compute building block, means for generating, the means for generating to generate a number of credits for the producing compute building block corresponding to the configuration information, the configuration information including characteristics of a buffer, means for analyzing to determine whether the returned credit originates from the producing compute building block or a consuming compute building block, and means for duplicating to, when the returned credit originates from the producing compute building block, multiply the returned credit by a first factor, the first factor indicative of a number of consuming compute building blocks identified in the configuration information.

Example 22 includes the apparatus of example 21, further including a means for aggregating, the means for aggregating to combine multiple returned credits from the number of consuming compute building blocks corresponding to the first factor into a single producer credit when the returned credit originates from the consuming compute building block.

Example 23 includes the apparatus of example 22, wherein the means for aggregating are to query a counter to determine when to combine the multiple returned credits into the single producer credit, the counter to increment each time a credit corresponding to a location in a memory is returned.

Example 24 includes the apparatus of example 23, wherein the means for communicating are to wait to provide the producing compute building block the single producer credit until each of the number of consuming compute building blocks have returned a credit.

Example 25 includes the apparatus of example 21, wherein the means for communicating are to send a credit to each of the number of consuming compute building blocks corresponding to the first factor.

From the foregoing, it will be appreciated that example methods, apparatus and articles of manufacture have been disclosed that manage a credit system between one producing computational building block and multiple consuming computational building blocks. The disclosed methods, apparatus and articles of manufacture improve the efficiency of using a computing device by providing a credit manager to abstract away a number of consuming CBBs to remove and/or eliminate the logic typically required for a consuming CBB to communicate with a producing CBB during execution of a workload. As such, a configuration controller does not need to configure the producing CBB to communicate directly with a plurality of consuming CBBs. Such configuring of direct communication is computationally intensive because the producing CBB would need to know the type of consuming CBB, the speed at which the consuming CBB can read data, the location of the consuming CBB, etc. Additionally, the credit manager facilitates multiple consuming CBBs for execution of a workload, regardless of the speed at which the multiple consuming CBBs operate. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a communication processor to receive configuration information from a producing compute building block;
a credit generator to generate a number of credits for the producing compute building block corresponding to the configuration information, the configuration information including characteristics of a buffer;
a source identifier to analyze a returned credit to determine whether the returned credit originates from the producing compute building block or a consuming compute building block; and
a duplicator to, when the returned credit originates from the producing compute building block, multiply the returned credit by a first factor, the first factor indicative of a number of consuming compute building blocks identified in the configuration information.

2. The apparatus of claim 1, wherein the producing compute building block is to produce a stream of data for one or more consuming compute building blocks to operate on.

3. The apparatus of claim 1, further including an aggregator to, when the source identifier identifies the returned credit originates from the consuming compute building block, combine multiple returned credits from a number of consuming compute building blocks corresponding to the first factor into a single producer credit.

4. The apparatus of claim 3, wherein the aggregator is to query a counter to determine when to combine the multiple returned credits into the single producer credit, the counter is to increment each time a credit corresponding to a location in a memory is returned.

5. The apparatus of claim 4, wherein a producing compute building block cannot receive the single producer credit until each of the number of consuming compute building blocks corresponding to the first factor have returned a credit.

6. The apparatus of claim 1, wherein the communication processor is to send a credit to each of the number of consuming compute building blocks.

7. The apparatus of claim 1, wherein the producing compute building block is to determine a size of the buffer, the buffer to have a number of slots corresponding to a second factor for storing data produced by the producing compute building block.

8. The apparatus of claim 1, wherein the configuration information identifies the number of consuming compute building blocks per single producing compute building block.

9. A non-transitory computer readable storage medium comprising instructions that, when executed, cause a processor to at least:
receive configuration information from a producing compute building block;
generate a number of credits for the producing compute building block corresponding to the configuration information, the configuration information including characteristics of a buffer;
analyze a returned credit to determine whether the returned credit originates from the producing compute building block or a consuming compute building block; and
when the returned credit originates from the producing compute building block, multiply the returned credit by a first factor indicative of a number of consuming compute building blocks identified in the configuration information.

10. The non-transitory computer readable storage medium as defined in claim 9, wherein the instructions, when executed, cause the processor to produce a stream of data for one or more consuming compute building blocks to operate on.

11. The non-transitory computer readable storage medium as defined in claim 9, wherein the instructions, when executed, cause the processor to, when the returned credit originates from the consuming compute building block, combine multiple returned credits from the number of consuming compute building blocks corresponding to the first factor into a single producer credit.

12. The non-transitory computer readable storage medium as defined in claim 11, wherein the instructions, when executed, cause the processor to query a counter to determine when to combine the multiple returned credits into the single producer credit, the counter to increment each time a credit corresponding to a location in a memory is returned.

13. The non-transitory computer readable storage medium as defined in claim 12, wherein the instructions, when executed, cause the processor to not provide the producing compute building block the single producer credit until each of the number of consuming compute building blocks corresponding to the first factor have returned a credit.

14. The non-transitory computer readable storage medium as defined in claim 9, wherein the instructions, when executed, cause the processor to send a credit to each of the number of consuming compute building blocks.

15. The non-transitory computer readable storage medium as defined in claim 9, wherein the instructions, when executed, cause the processor to determine the number of consuming compute building blocks per single producing compute building block based on the configuration information.

16. A method comprising:
receiving configuration information from a producing compute building block;
generating a number of credits for the producing compute building block corresponding to the configuration information, the configuration information including characteristics of a buffer;
analyzing a returned credit to determine whether the returned credit originates from the producing compute building block or a consuming compute building block; and
when the returned credit originates from the producing compute building block, multiplying the returned credit by a first factor is the first factor indicative of a number of consuming compute building blocks identified in the configuration information.

17. The method of claim 16, further including combining multiple returned credits from the number of consuming compute building blocks corresponding to the first factor into a single producer credit when the returned credit originates from the consuming compute building block.

18. The method of claim 17, further including querying a counter to determine when to combine the multiple returned credits into the single producer credit, the counter to increment each time a credit corresponding to a location in a memory is returned.

19. The method of claim 18, further including waiting to provide the producing compute building block the single producer credit until each of the number of consuming compute building blocks have returned a credit.

20. The method of claim 16, further including sending a credit to each of the number of consuming compute building blocks corresponding to the first factor.

21. An apparatus comprising:
means for communicating, the means for communicating to receive configuration information from a producing compute building block;
means for generating, the means for generating to generate a number of credits for the producing compute building block corresponding to the configuration information, the configuration information including characteristics of a buffer;
means for analyzing to analyze a returned credit to determine whether the returned credit originates from the producing compute building block or a consuming compute building block; and
means for duplicating to, when the returned credit originates from the producing compute building block, multiply the returned credit by a first factor, the first factor indicative of a number of consuming compute building blocks identified in the configuration information.

22. The apparatus of claim 21, further including a means for aggregating, the means for aggregating to combine multiple returned credits from the number of consuming compute building blocks corresponding to the first factor into a single producer credit when the returned credit originates from the consuming compute building block.

23. The apparatus of claim 22, wherein the means for aggregating are to query a counter to determine when to combine the multiple returned credits into the single producer credit, the counter to increment each time a credit corresponding to a location in a memory is returned.

24. The apparatus of claim 23, wherein the means for communicating are to wait to provide the producing compute building block the single producer credit until each of the number of consuming compute building blocks have returned a credit.

25. The apparatus of claim 21, wherein the means for communicating are to send a credit to each of the number of consuming compute building blocks corresponding to the first factor.
